(19) United States
(12) Patent Application Publication
(10) Pub. No.: US 2004/0144717 A1
(43) Pub. Date: Jul. 29, 2004

(54) Apparatus for separating immiscible liquids

(76) Inventor: Henry P. Sheng, Claremont, CA (US)

Correspondence Address: Boniard I. Brown, 1500 West Covina Parkway, #113, West Covina, CA, 91790-2793, US

(21) Appl. No.: 10/353,596

(22) Filed: Jan. 29, 2003

(51) Int. Cl. B01D 17/00

(52) U.S. Cl. 210/512.1; 210/513; 210/512.3

(57) ABSTRACT

Immiscible liquids are separated into heavier and lighter phases by centrifugal and centripetal forces, respectively, produced by disposing the immiscible liquid onto spinning components, and separately collecting the heavier and lighter phases.

### BACKGROUND OF THE INVENTION

The present invention provides apparatus and systems for the separation of immiscible liquids into heavier and lighter phases.

There has long existed a need for systems and apparatus for efficient separation of light and heavy phases of immiscible liquids.

A well-known means for effecting separation of light and heavy phases of immiscible liquids comprises large settlement tanks or enclosures. These require substantial time to effect separation, substantial land areas, and substantial labor and expense to construct, maintain and operate.

The present invention provides apparatus for utilizing centripetal and centrifugal forces for the separation of immiscible liquids. The apparatus comprises components which spin to effect these forces, and may typically include a generally conical member widening upwardly, and means for impelling the heavier phase against such member, while the lighter liquid phase is impelled generally radially inwardly by centripetal force. The respective heavier and lighter phases are conducted from the apparatus by conduits.

### BRIEF DESCRIPTION OF THE DRAWINGS

FIG. 1 is a generally elevational view of a preferred embodiment of the invention wherein immiscible liquid impinges upon an upper one of a plurality of rotating annular disks;

FIG. 2 is a sectional view taken at line 2-2 in FIG. 1;

FIG. 3 is a generally elevational view of an embodiment similar to that of FIG. 1 except for lack of a perforated conical member;

FIG. 4 is a sectional view taken at line 4-4 in FIG. 3;

FIG. 5 is an elevational view of an embodiment wherein a generally conical housing member is power-rotated and receives immiscible liquid by a conduit extending above the member;

FIG. 6 shows an embodiment similar to that of FIG. 5, wherein immiscible liquid is applied to the rotating conical member by a conduit extending upwardly axially from a lower portion of the device to impel a conical housing member;

FIG. 7 is an elevational view of an embodiment having a conical housing wherein are disposed an axial perforated hollow tube and frusto-conical perforated members on the tube and being power-rotated; and

FIG. 8 is a sectional view taken at line 8-8 in FIG. 7.

### DESCRIPTION OF THE PREFERRED EMBODIMENTS

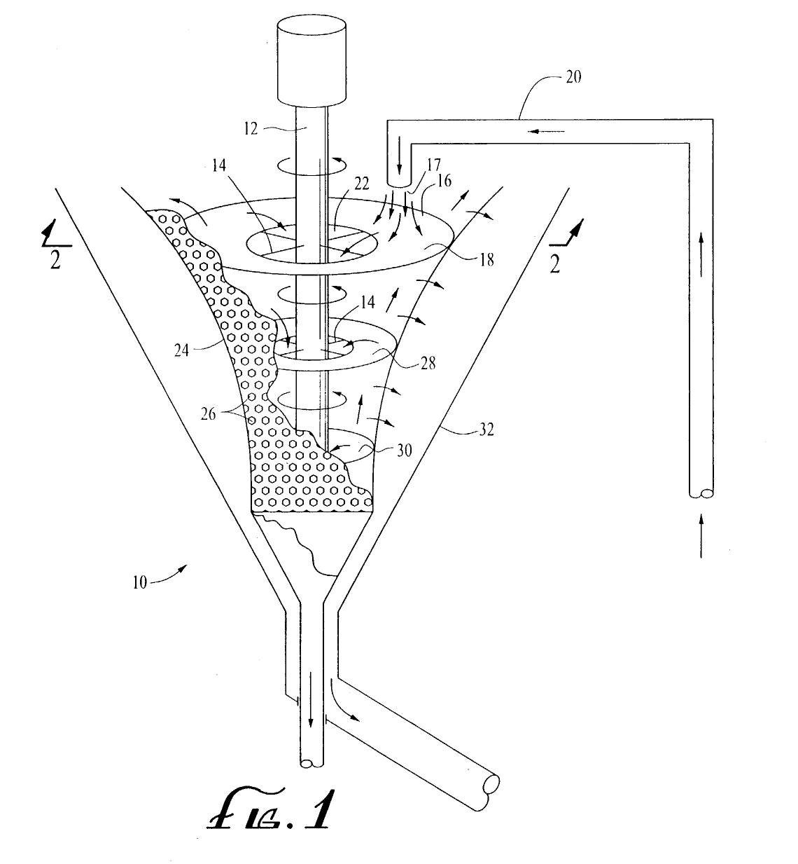

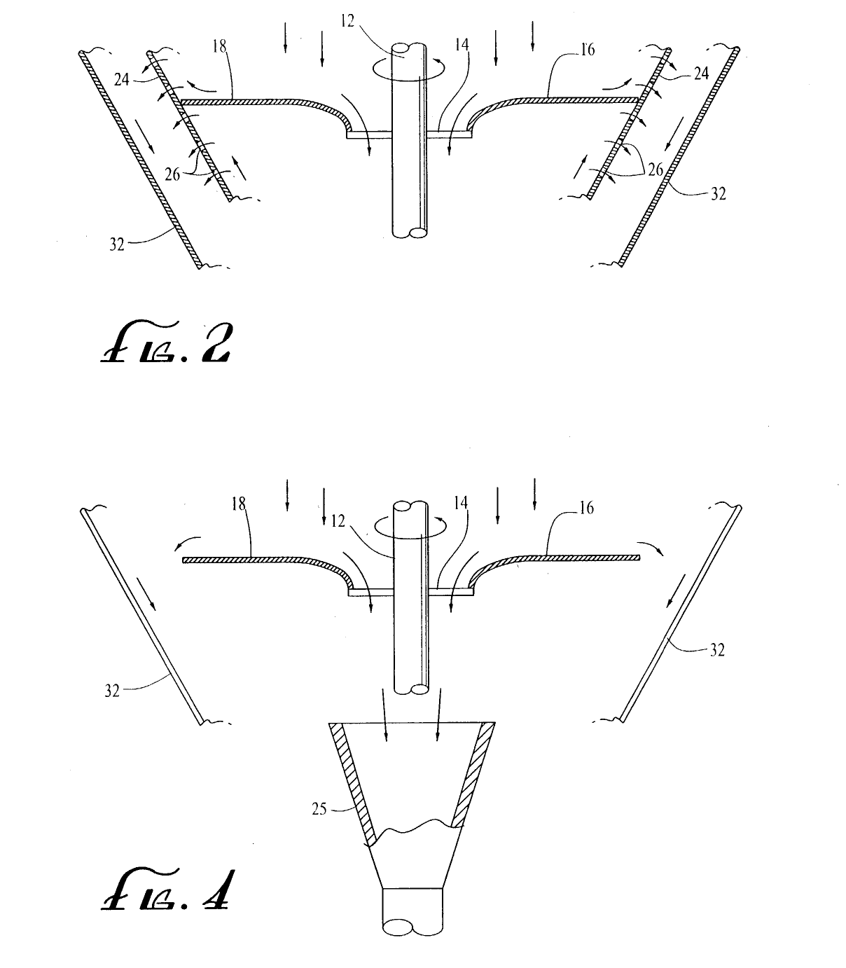

Referring to FIGS. 1 and 2 of the drawings, a preferred embodiment of the present invention 10 comprises an inner axial rotatable tubular member 12 which is connected by rod elements 14 to space apart annular disks 18, 28, 30 for rotation within stationary housing 32.

A stream of immiscible liquids is directed onto spinning upper annular disk 18 via a conduit 20 by pumping means (not shown). The liquid is urged from the upper annular disk by gravity to urge it downwardly by the circular disk and by centrifugal force urge it radially outwardly of the disks, as indicated by the directional arrows in FIGS. 1 and 2, passing downwardly via the central openings in the annular disks. As indicated by directional arrows in FIG. 1, a portion of the heavy phase is urged upwardly and outwardly to exit over the upper edge of the perforated spinning wall member 24, which flares outwardly in the upper direction, as shown. Heavy phase liquid passes outwardly via the perforations 26 in spinning member 24 and onto the stationary conical outer housing 32. That is, the heavy phase is impelled radially outwardly from the successively lower rotating disks 18, 28, 30 and passes through the perforations of member 24.

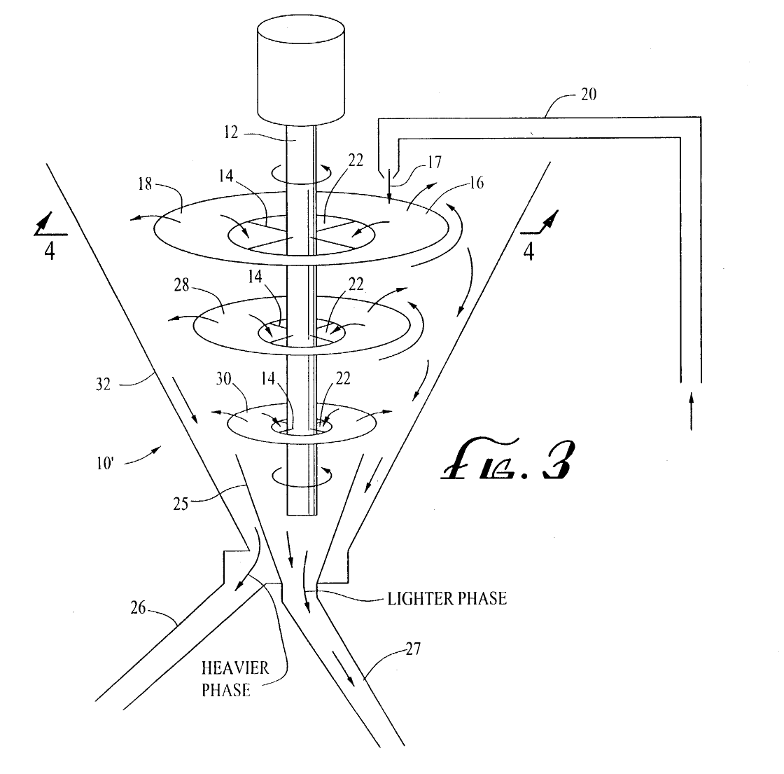

The lighter phase of the immiscible liquids passes under centripetal force radially inwardly to pass downwardly by gravity via the central openings of the annular disks, as generally indicated by arrows in FIGS. 1 and 3, and passes into the conduit shown to pass from the apparatus of the invention.

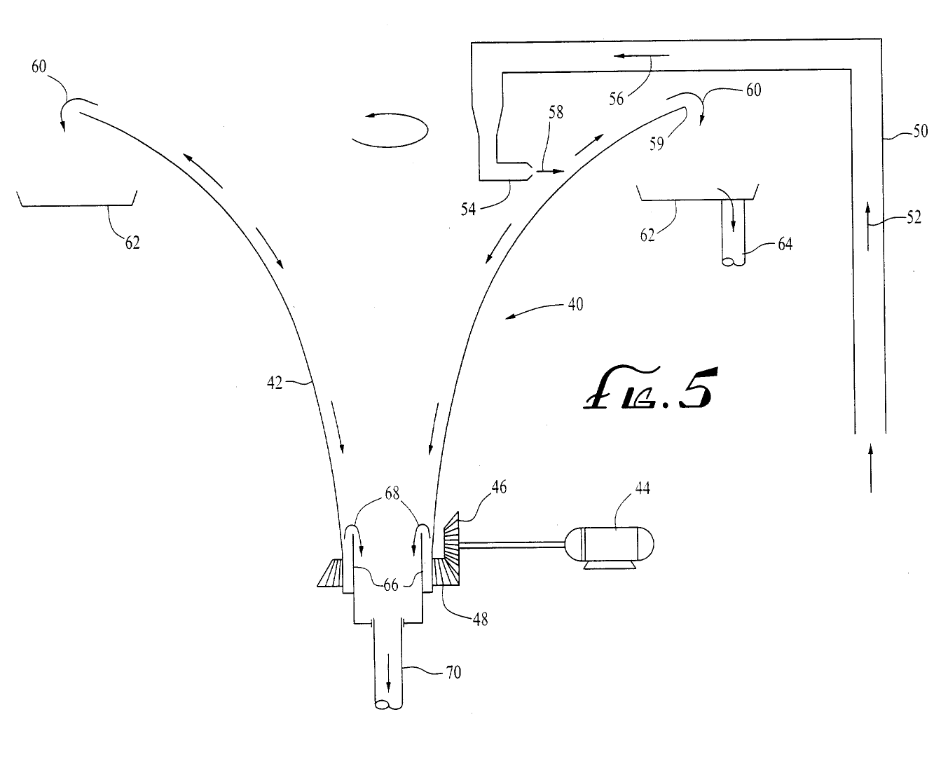

FIGS. 3 and 4 illustrate the embodiment of the invention similar to the embodiment of FIGS. 1 and 2, but which has no outer conical housing such as the housing 32 of the embodiment of FIG. 1.

An inner axial rotatable tubular member 12 is connected by rod elements 14 to space apart annular disks 18, 28, 30 for rotation with the tubular member 12.

A stream of immiscible liquids is directed onto the spinning upper annular disk 18 via a conduit 20 by pumping means (not shown). The liquid is urged from the upper disk by gravity downwardly, and is urged by centrifugal force radially outwardly of the disks, as indicated by the directional arrows shown in FIGS. 3 and 4, and passes downwardly via the central openings in the annular disks. As indicated by directional arrows in FIG. 3, a portion of the heavy phase is urged generally outwardly to exit by passing over the outer edge of upper disk 18. The heavier phase is impelled radially outwardly from the successively lower rotating disks 18, 28, 30, and passes downwardly via outer conical housing 32 to pass via a conduit 26 from the apparatus of the invention.

The lighter phase of the immiscible liquids passes under centripetal force radially and inwardly to pass downwardly via the central openings 22 of the annular disks, as generally indicated by the arrows in FIGS. 3 and 4, and thence passes a conduit 27 from the apparatus of the invention.

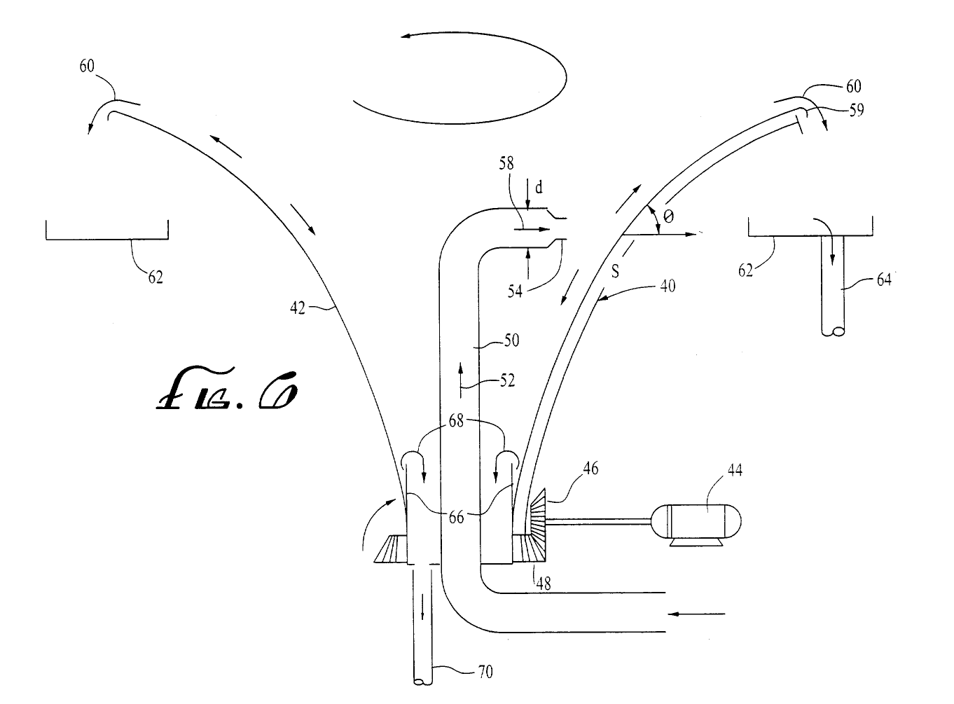

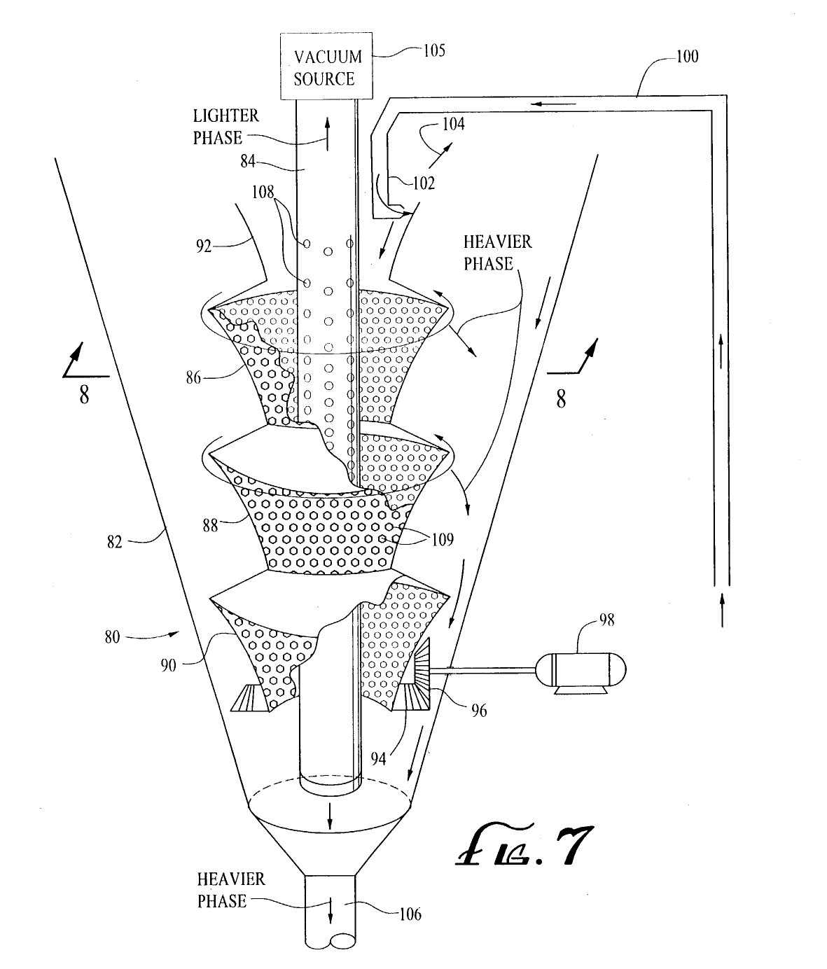

In FIGS. 5 and 6, an embodiment or apparatus 40 of the invention comprises an outer arcuately conical housing 42 adapted to be spun about its axis by an electrical motor 44 which rotates beveled gears 46, 48, gear 48 being mounted about a lower portion of the housing 42. A conduit 50 conducts the immiscible liquids as indicated by arrows 52, 56 which discharges the immiscible liquids to an inner upper portion of housing 42 via outlet portion 54 onto the upper inner surface portion of housing 42 as indicated by arrow 58. The heavier phase of the immiscible liquids passes radially and outwardly of the housing and along an upper portion of the housing to pass over the upper edge thereof as indicated by arrow 60. The flow of the heavier phase onto a generally annular trough 62 disposed below the upper edge 59 of the housing, and passes downwardly through a conduit 64 and passes through the apparatus of the invention. The lighter phase of the immiscible liquids generally passes inwardly by centripetal force and downwardly by gravity along the inner surface of the housing 42, some of said lighter phase passes through a weir 66 into the lower portion of the housing 42, as indicated by the arrows 68, and passes via a conduit 70 from the apparatus of the invention.

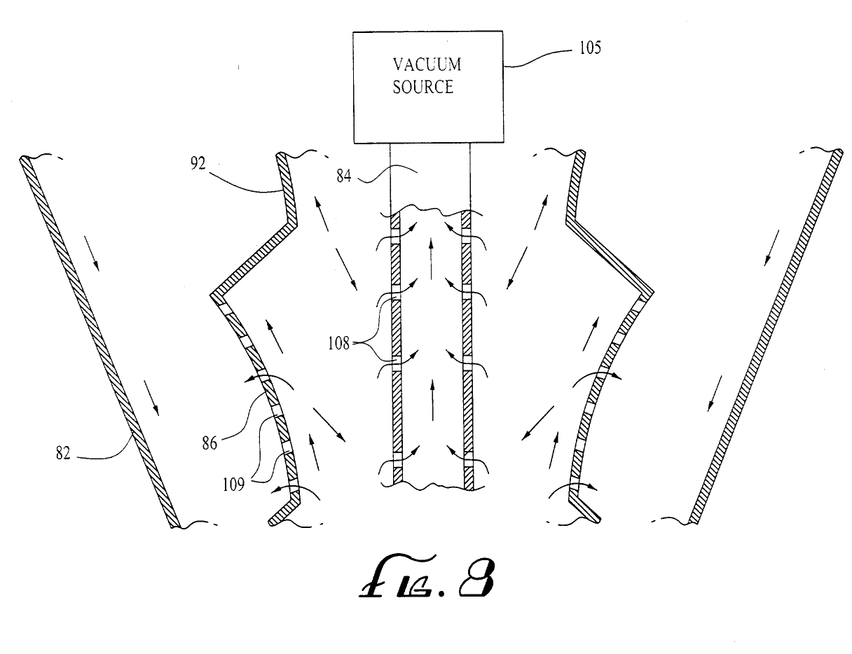

Referring to FIGS. 7 and 8, an apparatus 80 for separation of two immiscible liquids comprises an outer housing 82 of generally conical configuration and widening upwardly. The housing is stationary—i.e., non-rotating.

A central axial perforated tubular member 84 is generally coaxial with the outer housing 82.

A plurality, typically three, of generally frusto-conical perforated members 86, 88, 90 are secured to tubular member 84 and are in fluid communication with each other and with tubular member 84.

A generally conical, arcuate upper wall member 92 extends upwardly from an upper one of the contiguous perforated members.

A conduit 100 extends upwardly and inwardly of the assembly and has a bent portion 102 from which exits the immiscible liquids mixture onto the upper inner surface of wall member 92. The immiscible mixture partially passes generally upwardly and over the upper edge of the conical upper wall member 92.

A bevel gear 94 is mounted about a lower portion of the lower one of the frusto-conical perforated members and engages a gear 96 which is driven by electrical motor 98 to spin the tube 84 and perforated members 86, 88, 90.

A vacuum source 105 applies a partial vacuum upwardly through tube 84 to urge the lighter phase inwardly via the perforations 108 of tube 84 and the perforated members 86, 88, 90.

Some of the heavier phase of the immiscible liquids passes outwardly on the upper wall member 92, as indicated by arrow 104, over the upper edge thereof to fall by gravity to the inner surface of the housing 82, and some passes downwardly and outwardly via the perforations in the perforated members 86, 88, 90 and thence downwardly by gravity to the inner surface of housing 82. The heavier phase then passes via a conduit 106 to exit the apparatus of the invention.

The lighter phase is impelled radially inwardly by centripetal force into and within the frusto-conical perforated members and into the perforated tubular member 84 to pass upwardly under the action of the vacuum source 105 and pass via a conduit (not shown) to exit the apparatus of the invention.

The inventor claims:

1. Apparatus for separation of two immiscible liquids of first heavier phase and second lighter phase, said apparatus comprising:
a housing of generally conical configuration and mounted for spinning about an axis,
said housing widening upwardly,
means to spin said housing about said axis,
means to introduce a mixture of the two immiscible liquids into the interior of said housing,
said first heavier phase being impelled by centrifugal force generally radially outwardly against an interior of the housing, and moving downwardly by gravity,
said second lighter phase being impelled generally radially inwardly by centripetal force produced by the spinning of the housing, and moving downwardly by gravity,
means to conduct said heavier phase from the apparatus, and
means to conduct said lighter phase from the apparatus.

2. Apparatus according to claim 1 and further including collection means communicating with an inner portion of said housing to remove the first lighter phase.

3. Apparatus for separation of two immiscible liquids into a first heavier phase and a second lighter phase, said apparatus comprising:
an outer housing of generally conical configuration and widening upwardly,
a central axial shaft mounted for spinning about an axis,
a plurality of annular discs having central openings and being attached to said axial shaft in spaced relation,
an upper one of said annular discs being disposed to receive a flow of immiscible fluid,
means to spin said central shaft and the annular discs,
means to provide a flow of immiscible fluid onto said upper annular disc,
an upper generally conical perforated member disposed about said annular discs and inwardly of said outer housing,
said heavier phase being impelled generally radially outwardly from the annular discs and via said perforations in the inner conical member, and toward the outer conical housing, and further being moved downwardly by gravity,
said lighter phase being impelled generally inwardly by centrepetal force and passing via said annular discs in the annular members via said openings therein, and being moved downwardly by gravity,
means to conduct the separated heavier phase from the apparatus, and
means to conduct said separated lighter phase from the apparatus.

4. Apparatus according to claim 3 wherein said annular disks decrease in diameter downwardly.

5. Apparatus according to claim 3 wherein said conical perforated member is arcuate and inwardly tapering in a downward direction.

6. Apparatus according to claim 3 wherein the separated heavier phase is conducted from the apparatus by a conduit at a lower portion of the apparatus, and said lighter phase is conducted by a separate conduit at a lower portion of the apparatus.

7. Apparatus for separation of two immiscible liquids into a first heavier phase and a second lighter phase, said apparatus comprising:
a housing of generally conical configuration and widening upwardly,
a central axis shaft mounted for spinning about an axis,
a plurality of annular discs having central openings and being attached in spaced relation to said axial shaft,
an upper one of said annular discs being disposed to receive a flow of immiscible fluid,
means to spin said central shaft and annular discs,
means to provide a flow of immiscible fluid onto said upper annular disc,
said heavier phase being impelled generally radially outwardly from the annular discs and toward the outer conical housing, and being moved downwardly by gravity,
said lighter phase being impelled generally inwardly by centripetal force and passing via said annular discs in the annular members via said openings therein, and being moved downwardly by gravity,
means to conduct the separated heavier phase from the apparatus, and
means to conduct said separated lighter phase from the apparatus.

8. Apparatus according to claim 6, wherein said immiscible liquid mixture is dispensed onto an upper inner portion of the interior surface of the conical housing via a conduit extending into the housing and having an upper bent portion to impel the immiscible liquid mixture onto said surface of the housing.

9. Apparatus for the separation of two immiscible liquids into a first heavier phase and second lighter phase, said apparatus comprising:
an outer housing of generally conical configuration and widening upwardly,
means to spin said housing about its axis,
conduit means to provide a flow of the immiscible fluid into the interior wall of the outer housing,
the heavier phase is urged outwardly and upwardly on the housing by centrifugal force and passes over the upper edge of the housing,
a generally annular trough disposed under the upper edge of the outer periphery of the housing to receive the heavier phase dropped from the upper edge of the housing,
the lighter phase being impelled generally inwardly by centripetal force, and being moved downwardly in the housing by gravity,
means to conduct the separated heavier phase from the apparatus, and
means to conduct said separated lighter phase from the apparatus.

10. Apparatus according to claim 9 and comprising an arcuate trough to receive said liquid from said upper edge,
a conduit connected with the trough to conduct said liquid from the apparatus, and
collection means disposed about and below the top edge portion of the housing.

11. Apparatus for the separation of two immiscible liquids into a first heavier phase and a second lighter phase, said apparatus comprising:
an outer housing of generally conical configuration and widening upwardly.
a central perforated tubular member generally coaxial with the outer housing,
a plurality of generally frustoconical perforated members attached to the central tubular member, and being in fluid communication with each other,
said perforated generally conical members being in fluid communication with each other,
a generally conical upper wall member extending upwardly from an upper one of the contiguous perforated members,
said heavier phase being impelled generally radially outwardly and upwardly along said upper wall member and over an upper perimeter edge thereof,
the heavier phase liquid passing over said wall member upper edge and being impelled by centrifugal force radially outwardly and downwardly through the frustoconical perforated members perforations and radially outwardly therefrom,
said lighter phase being impelled generally radially inwardly by centripetal force and downwardly by gravity to pass via the perforated members into the tubular perforated member to pass upwardly therethrough,
means to conduct the separated heavier phase from the apparatus, and
means to conduct said separated lighter phase from the apparatus.

12. Apparatus according to claim 11, wherein said frusto-conical perforated members are three in number.

13. Apparatus according to claim 11, wherein said frusto-conical perforated members are mutually contiguous.
